(19) United States
(12) Patent Application Publication
(10) Pub. No.: US 2010/0268714 A1
(43) Pub. Date: Oct. 21, 2010

(54) SYSTEM AND METHOD FOR ANALYSIS OF INFORMATION

(75) Inventors: Yeong Ho Moon, Seoul (KR); Sang Pil Lee, Seongnam-si (KR); Chang Hoan Lee, Seongnam-si (KR); Sang Jin Bae, Yongin-si (KR); June Young Lee, Seoul (KR); Oh Jin Kwon, Seoul (KR); Bang Rae Lee, Seoul (KR); Eui Seob Jeong, Seoul (KR); Woon Dong Yeo, Seoul (KR)

Correspondence Address: LRK Patent Law Firm, 1952 Gallows Rd, Suite 200, Vienna, VA, 22182, US

(73) Assignee: KOREA INSTITUTE OF SCIENCE & TECHNOLOGY INFOMATION, Daejeon (KR)

(21) Appl. No.: 12/808,323

(22) PCT Filed: Dec. 16, 2008
(86) PCT No.: PCT/KR08/07439

§ 371 Date: Jun. 16, 2010

(30) Foreign Application Priority Data
Dec. 21, 2007 (KR) 10-2007-0135050

(51) Int. Cl. G06F 17/30

(52) U.S. Cl. 707/737; 707/E17.089

(57) ABSTRACT

The present invention relates to an information analysis system comprising: a summary table creation unit for analyzing an input file if the file is inputted, extracting a field list corresponding to the field list information stored in a provided database, and creating a summary table including the extracted field list; a preprocessing module for performing a preprocess including at least one of field refinement, group creation, and sub-data set creation, for fields of the summary table created by the summary table creation unit; a matrix creation unit for creating a matrix based on matrix setting information inputted by a user, for the fields created by the summary table creation unit or the preprocessing module; a cluster analysis unit for analyzing a cluster of corresponding fields according to a cluster analysis method inputted by the user, for fields selected by the user among the fields created by the summary table creation unit or the preprocessing module; and a visualization data creation unit for creating visualization data according to a visualization method selected by the user, for data created by at least one of the matrix creation unit, the preprocessing module, and the cluster analysis unit, in which methods such as a matrix, preprocessing, cluster analysis, and the like are allowed to be used in analyzing files so that accuracy and efficiency of information analysis can be enhanced.

### TECHNICAL FIELD

The present invention relates to an information analysis system and a method thereof, and more specifically, to an information analysis system and a method thereof, which receive a database file or matrix values and provide a matrix creation function, a data preprocessing function, a cluster analysis function, and a visualization function.

### BACKGROUND ART

Knowledge that grows through the medium of information is an intangible asset embodied in a human itself as a result of human's thinking and innovation. Such intangible knowledge possessed by a human is handed over and transferred through a variety of communications. Particularly, papers, patents, and the like are important media for transferring such knowledge and important first information resources. That is, it is a symbiosis age of information and scientific technologies.

Particularly, as revolution of knowledge is accelerated with the advent of the Internet, manifestation of information and knowledge is explosively increased.

Information resources needed for research activities include various kinds of information such as information on researchers, research institutes, research facilities, communities, industrial markets, and the like, in addition to library information such as papers, patents, and the like. However, although such information resources needed for research activities are mainly searched for centering on opened papers and patents before the Internet is introduced, even the information collected based on the ability and capability of individual researchers can be easily accessed owing to the advancement of the Internet. As most of such various kinds of information are opened and accessible online, the amount of available information resources is gradually increased.

Researchers and research planning managers suffer from the problem of efficiently utilizing such a large amount of information for research activities.

Inquiry and analysis of information are very important in performing a research activity. Particularly, as information resources are geometrically increased, a work of extracting knowledge meaningful to a research from the information resources, i.e., monitoring various forms of changes in patterns contained in external information resources and strategically utilizing the changes, rather than simply inquiring individual items needed to a user, becomes further important.

Such a work is a portion of a subject itself performing a research, as well as of a researcher of information econometric analysis who specifically studies changes in the phase of activities of the whole science and technology. It is since that grasping overall research trends, analyzing positioning of a research being performed, and establishing a prompt counter-strategy are emerged as essential factors of competitiveness of the research.

In addition, whether researchers properly lead the direction of a research project or objective of a research from the viewpoint of a country or enterprises, or whether global trends of science and technology are sufficiently reviewed and reflected is considered further more important. It is since that analysis on the trends of research directions and positioning of a research project currently to be performed is essential for efficient investment of limited resources. Making it obligatory recently to perform prior search of papers and patents in analyzing research trends when a variety of national research and development projects are planned can be considered as reflecting such trends to some extent.

On the other hand, with the advancement in scientometrics and infometrics as an academic method, a variety of techniques for information analysis systems has been developed to apply them to a practical problem.

Representatively, library information analysis systems, such as VantagePoint of Georgia Tech in USA, BinTechMon of Austrian research corporation (ARC), and CiteSpace of Indiana University in USA, can be referred to as typical tools. Other than these, a variety of tools connected to patent databases for providing an analysis function, such as Aureka of MicroPatent, Delphion Patlab, and the like, are being developed. In addition, InXight, Omni Viz, SciFinder Panorama, and the like focusing on visualization of searched data have been introduced.

However, although a variety of analysis systems has been developed since the late 1990's, there is a limitation in solving a problem practically utilizing such analysis systems.

First, many of the analysis systems are supposed to use a DB and thus excessively subordinates to a specific DB.

Second, there is a problem in that if an analysis system combines with a DB, refining and free editing of data essential for precise analysis are not allowed.

Third, it is disadvantageous in that analysis systems in the prior art are not designed to allow a user to freely associate desired items and perform a variety of analyses, but designed to provide only a specific function.

Fourth, analysis systems in the prior art do not sufficiently reflect requests of real consumers. That is, rather than exerting an effort to systemize requirements needed in the regard of consumers for utilizing information analysis or develop various kinds of utilization logic using an analysis system, the analysis systems in the prior art put a stress on visualization of patterns shown in structured information resources. Accordingly, although the real consumers utilize existing information analysis systems, they are always in a difficulty of analysis, or difficulty of unable to perform actually desired analysis.

### DISCLOSURE OF INVENTION

### Technical Problem

Accordingly, the present invention has been made in order to solve the above problems, and it is an object of the invention to provide an information analysis system and a method thereof, which can extract and convert new knowledge by applying a variety of analysis techniques to library and patent databases, in which information generated in research and development activities is systematically structured, depending on purposes of users.

Another object of the invention is to provide an information analysis system and a method thereof, which can find out and provide applied analysis examples of systems reflecting requests of field consumers and formulate the examples into logic to be implemented in a system.

A further object of the invention is to provide an information analysis system and a method thereof, which can support preprocessing collected information resources in order to associate and refine items desired to be analyzed, extract a pattern from extracted data, and visualize the data.

A further object of the invention is to provide an information analysis system and a method thereof, in which a user of an information analysis system can freely associate desired items and perform a variety of analyses.

A further object of the invention is to provide an information analysis system and a method thereof, in which methods such as a matrix, preprocessing, cluster analysis, and the like are allowed to be used in analyzing files so that accuracy and efficiency of information analysis can be enhanced.

A further object of the invention is to provide an information analysis system and a method thereof, which can provide a different custom-tailored information analysis result depending on a user.

### Technical Solution

In order to accomplish the above objects of the invention, according to one aspect of the invention, there is provided an information analysis server for analyzing information, comprising: a database for storing field list information and file information; a summary table creation unit for analyzing an input file if the file is inputted, extracting a field list corresponding to the field list information stored in the database, and creating a summary table including the extracted field list; a preprocessing module for performing a preprocess including at least one of field refinement, group creation, and sub-data set creation, for fields of the summary table created by the summary table creation unit; a matrix creation unit for creating a matrix based on matrix setting information inputted by a user, for the fields created by the summary table creation unit or the preprocessing module; and a cluster analysis unit for analyzing a cluster of corresponding fields according to a cluster analysis method inputted by the user, for fields selected by the user among the fields created by the summary table creation unit or the preprocessing module.

The information analysis server further comprises a visualization data creation unit for creating visualization data according to a visualization method selected by the user, for data created by at least one of the matrix creation unit, the preprocessing module, and the cluster analysis unit.

The visualization method includes at least one of a chart, a FDP, and a strategic map, and the file is inputted in the form of text or a matrix.

The summary table created by the summary table creation unit includes the number of contents and fidelity of each field of the field list.

The preprocessing module comprises: a field refinement unit for refining fields selected according to a field refinement method inputted by the user; a group setting unit for setting a group according to a group setting method inputted by the user; and a sub-data set creation unit for creating a sub-data set according to a sub-data set creation method inputted by the user.

The field refinement method is at least one of creation of a field using a group, creation of a field using a thesaurus, creation of a field using a cluster, Refine Field, and Combine Field, and the group setting method may be at least one of New Grouping, Add to Group, Edit Group, creation of a group using thesaurus, and creation of a group using stemming.

The sub-data set creation method is one of a method of creating a sub-data set using a group and a method creating a sub-data set using field data.

The matrix setting information includes a matrix type, a matrix creation type, and a proximity calculation type, and the matrix type includes an occurrence matrix type, a co-occurrence matrix type, and a proximity matrix type.

The matrix creation type includes a matrix creation type based on a record and a matrix creation type using calculation of the number of field data appearing in a record.

The cluster analysis unit analyzes a cluster by extracting entities corresponding to the fields selected by the user from the database and calculating proximity among the entities.

The cluster analysis method includes at least one of Single, Complete, Average, Ward, and K-Means.

According to another aspect of the invention, there is provided an information analysis method, comprising the steps of: (a) extracting a field list by analyzing an input file if the file is inputted, and creating a summary table including the number of unique items and data fidelity of each field of the extracted field list; (b) providing a setting screen for an input command if at least one of a matrix creation command, a preprocessing command, and a cluster analysis command is inputted for the fields of the created summary table, and processing corresponding fields based on corresponding setting information if the setting information is inputted through the provided setting screen; and (c) creating and outputting visualization data for a result of the processing according to a selected visualization method if a visualization command is inputted for the result of the performed processing.

Step (a) comprises the steps of: providing a file input screen if an information analysis menu is selected; analyzing an input file and extracting a field list corresponding to fields selected through the file input screen, if the file is inputted through the file input screen; and creating a summary table including the number of unique items and data fidelity of each field of the extracted field list.

Step (b) comprises the steps of: providing a matrix setting screen if a matrix setting command is inputted; and creating a matrix based on matrix setting information for the fields of the created summary table if the matrix setting information is inputted through the matrix setting screen.

The matrix setting screen is configured with a matrix type selection area, a matrix creation type selection area, and a proximity calculation type selection area, wherein the matrix type selection area displays an occurrence matrix type, a co-occurrence matrix type, a proximity matrix type, and the matrix creation type selection area displays a record-based matrix creation type and a matrix creation type of calculating appearance of field data in a record.

In addition, step (b) comprises the steps of: providing a corresponding preprocess setting screen if a preprocessing command including at least one of a field refinement, a group creation, and a sub-data set creation is inputted; and performing a preprocess on corresponding fields based on preprocess setting information if the preprocess setting information is inputted through the preprocess setting screen.

In addition, step (b) comprises the steps of: providing a cluster analysis method selection screen if a cluster analysis command is inputted for a specific field of the created summary table; and analyzing a cluster for field items according to a cluster analysis method selected through the cluster analysis method selection screen.

### Advantageous Effects

Accordingly, the present invention can provide an information analysis system and a method thereof, which can extract and convert new knowledge by applying a variety of analysis techniques to library and patent databases, in which information generated in research and development activities is systematically structured, depending on purposes of users.

In addition, the present invention can provide an information analysis system and a method thereof, which can support preprocessing collected information resources in order to associate and refine items desired to be analyzed, extract a pattern from extracted data, and visualize the data.

In addition, the present invention can provide an information analysis system and a method thereof, in which a user of an information analysis system can freely associate desired items and perform a variety of analyses.

In addition, the present invention can provide an information analysis system and a method thereof, in which methods such as a matrix, preprocessing, cluster analysis, and the like are allowed to be used in analyzing files so that accuracy and efficiency of information analysis can be enhanced.

In addition, the present invention can provide an information analysis system and a method thereof, which can provide a different custom-tailored information analysis result depending on a user.

Furthermore, it is possible to provide an information analysis system and a method thereof for analyzing information, which can help field experts to easily express their expertise and users to obtain most essential information needed in performing researches.

### BRIEF DESCRIPTION OF THE DRAWINGS

FIG. 1 is a view showing the configuration of an information analysis system according to the present invention.

FIG. 2 is a block diagram schematically showing the configuration of an information analysis server according to the present invention.

FIG. 3 is a flowchart illustrating a method of analyzing an inputted file by the information analysis server according to the present invention.

FIG. 4 is an exemplary view showing a screen for inputting a file according to the present invention.

FIG. 5 is an exemplary view showing a summary table screen according to the present invention.

FIG. 6 is an exemplary view showing a matrix setting screen according to the present invention.

FIG. 7 is a flowchart illustrating a method of refining field information by the information analysis server according to the present invention.

FIG. 8 is an exemplary view showing a screen for selecting a method of refining a field according to the present invention.

FIGS. 9a and 9b are exemplary views showing a screen for creating a field according to the present invention.

FIG. 10 is a flowchart illustrating a method of creating a group by the information analysis server according to the present invention.

FIG. 11 is an exemplary view showing a screen for selecting a method of creating a group according to the present invention.

FIG. 12 is an exemplary view illustrating a method of creating a group using a thesaurus according to the present invention.

FIG. 13 is a flowchart illustrating a method of creating a sub-data set according to the present invention.

FIG. 14 is an exemplary view showing a screen for selecting a method of creating a sub-data set according to the present invention.

FIG. 15 is a flowchart illustrating a method of analyzing a cluster according to the present invention.

FIG. 16 is an exemplary view showing a screen for selecting a method of analyzing a cluster according to the present invention.

### MODE FOR THE INVENTION

Details of the objects, technical configurations, and operational effects of the present invention described above will be further clearly understood hereinafter according to the detailed descriptions with reference to the drawings accompanied in the specification of the present invention.

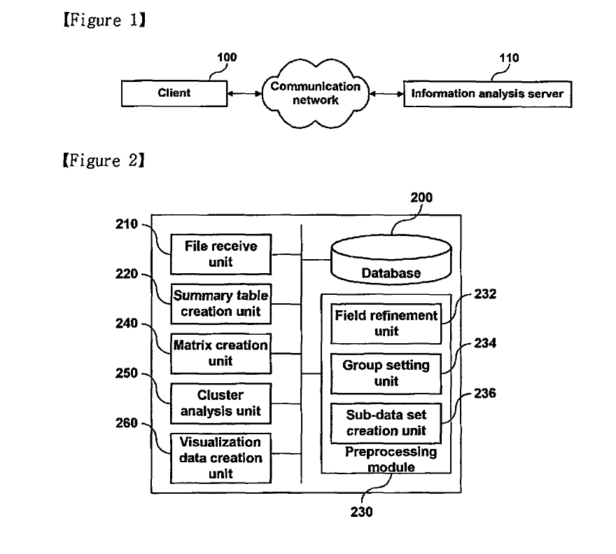

FIG. 1 is a view showing the configuration of an information analysis system according to the present invention.

Referring to FIG. 1, the information analysis system comprises a client 100 for receiving a file desired to be analyzed, and an information analysis server 110 for analyzing the file transmitted from the client 100 and creating a summary table.

The client 100 refers to a wired communication terminal, a wireless communication terminal, or the like, which is connected to the information analysis server 110 through a communication network.

The information analysis server 110 extracts a field list by analyzing the file transmitted from the client 100 and creates a summary table including the number of unique items and fidelity of each field of the extracted field list.

In addition, if a matrix creation command is inputted for at least one of the fields displayed on the created summary table, the information analysis server 110 creates a matrix based on matrix set information inputted by the client 100.

In addition, if preprocessing is requested for the fields displayed on the created summary table, the information analysis server 110 performs a corresponding preprocess. Here, the preprocessing may include creation of a field, creation of a group, creation of a sub-data set, and the like.

In addition, the information analysis server 110 analyzes a cluster for a field or entity selected by the client 100 according to a cluster analysis method inputted by the client 100.

The information analysis server 110 performing the functions described above will be described in detail referring to FIG. 2.

FIG. 2 is a block diagram schematically showing the configuration of an information analysis server according to the present invention.

Referring to FIG. 2, the information analysis server 110 includes a database 200, a file receive unit 210, a summary table creation unit 220, a preprocessing module 230, a matrix creation unit 240, a cluster analysis unit 250, and a visualization data creation unit 260.

The database 200 stores field list information and file information.

The file receive unit 210 receives a file from the client and transmits the file to the summary table creation unit 220. Here, the file can be inputted in the form of a web document, text, word, matrix, or the like.

If the file is received from the file receive unity 210, the summary table creation unit 220 analyzes the received file and extracts a field list stored in the database 200. Next, the summary table creation unit 220 obtains the number of unique items and fidelity of each field of the extracted field list and creates a summary table as shown in FIG. 5.

That is, if a file of a text or word form is inputted, the summary table creation unit 220 analyzes the file and extracts a field list corresponding to a field list set in the database 200. Next, the summary table creation unit 220 obtains the number of unique items (number of contents) and data fidelity of each field for the extracted field list and creates a summary table. Accordingly, the summary table expresses a field list, together with the number of contents and fidelity of each field.

The preprocessing module 230 performs a preprocessing process for the fields provided by the summary table created by the summary table creation unit 220 and includes a field refinement unit 232, a group setting unit 234, and a sub-data set creation unit 236.

The field refinement unit 232 refines a selected field according to a field refinement method inputted by the client. Here, the field refinement method includes methods such as creation of a field using a group, creation of a field using a thesaurus, creation of a field using a cluster, refine field, combine field, and the like.

The group setting unit 234 sets a group according to a group setting method inputted by the client. Here, the group setting method includes methods such as addition of a new group, creation of a group using a thesaurus, creation of a group using stemming, and the like.

The sub-data set creation unit 236 creates a sub-data set according to a sub-data set creation method inputted by the client. Here, the sub-data set creation method includes methods such as creation of a sub-data set using a group, creation of a sub-data set using a dragged area, and the like.

By the preprocessing operation of the preprocessing module 230 configured as described above, another summary table different from the summary table created by the summary table creation unit 220 can be created for a corresponding file. That is, the summary table created by the preprocessing module is a new summary table created in a method of refining fields, setting a group, or the like, which is different from the summary table including all fields created by the summary table creation unit.

The matrix creation unit 240 creates a summary statistics quantity of matrix values for the fields created by the summary table creation unit 220, according to a method set by the client or by default such as an occurrence matrix, co-occurrence matrix, proximity matrix, or the like.

In addition, the matrix creation unit 240 creates a summary statistics quantity of matrix values for the fields created by the preprocessing module 230, according to a method set by the user or by default such as an occurrence matrix, co-occurrence matrix, proximity matrix, or the like.

The cluster analysis unit 250 analyzes a cluster for a field (or an entity) selected by the client using a cluster analysis method selected by the client.

For example, if the client selects a cluster command by selecting an ‘inventor’ field, the cluster analysis unit 250 extracts an inventor stored in the provided database 200 and analyzes a cluster for the extracted inventor using a cluster analysis method selected by the client.

The cluster analysis is a statistical analysis technique tried to confirm a group having a similar characteristic, i.e., binding entities having a similar characteristic and dividing the entire entities into a plurality of groups or clusters.

Accordingly, the cluster analysis unit 250 analyzes a cluster for the entities using proximity. That is, the cluster analysis unit 250 obtains distances among the entities, calculates proximity using the obtained distances, and analyzes a cluster using the proximity.

The cluster analysis method includes a hierarchical method (single, complete, average, and ward), a non-hierarchical method (K-Means), and the like, and an order of the clustered items can be confirmed through a directory structure as a result of the cluster analysis.

The hierarchical clustering method includes methods of single, complete, average, central linkage, and the like. The single linkage (connected) uses the shortest distance among the distances of all entity pairs of two clusters as a measure of proximity between the clusters, which evaluates proximity of the two clusters using a pair of entities having the shortest distance.

The complete linkage (compact) uses the longest distance among the distances of all entity pairs of two clusters as a measure of proximity between the clusters, which evaluates proximity of the two clusters using a pair of entities having the longest distance.

The average linkage uses an average distance of all entity pairs of two clusters as a measure of proximity between the clusters.

The central coordinate of entities configuring a cluster is the center of the cluster, and the central linkage method is a method using a distance between the centers of two clusters as a measure of proximity between the clusters.

The non-hierarchical clustering method is also referred to as a partitioning method, which is a method of assigning the number of clusters in advance and allocating target entities to an appropriate cluster.

The K-Means clustering method among the non-hierarchical clustering methods selects coordinates of k entities as central coordinates of initial clusters according to a certain rule, calculates a distance to the central coordinates of k clusters for each entity, allocates the entity to the nearest cluster, calculates a central coordinate for a new cluster, and compares a newly created central coordinate value with a previous coordinate value. The process is terminated if a result of the comparison is within a convergence condition, otherwise central coordinates of the initial clusters are re-selected.

The visualization data creation unit 260 creates at least one of data created by the matrix creation unit 240, data created by the preprocessing module 230, and data analyzed by the cluster analysis unit 250 as visualization data such as a chart, FDP, strategic map, or the like by the request of the client.

The FDP is supported with a variety of options and thus can derive a visualization result in a desired form, and since the final position is changed depending on an initial value, it is preferable to repeat random initialization for a number of times until a layout best for analysis is rendered.

The strategic map forms a cluster based on a pattern of keywords concurrently appearing in a document, calculates strength of linkage within the cluster and strength of linkages with other clusters, and grasps a level of each item by strategically mapping geometrical features of a corresponding research field shown in the data on a quadrant.

In addition, the visualization data creation unit 260 randomly or uniformly distributes respective entities, calculates gravitation and repulsive forces, and creates and outputs visualization data for each entity by comparing the calculated gravitation and repulsive forces.

The information analysis server configured as described above receives a database file or matrix values and provides a matrix creation function, a data preprocessing function, a cluster analysis function, and a visualization function.

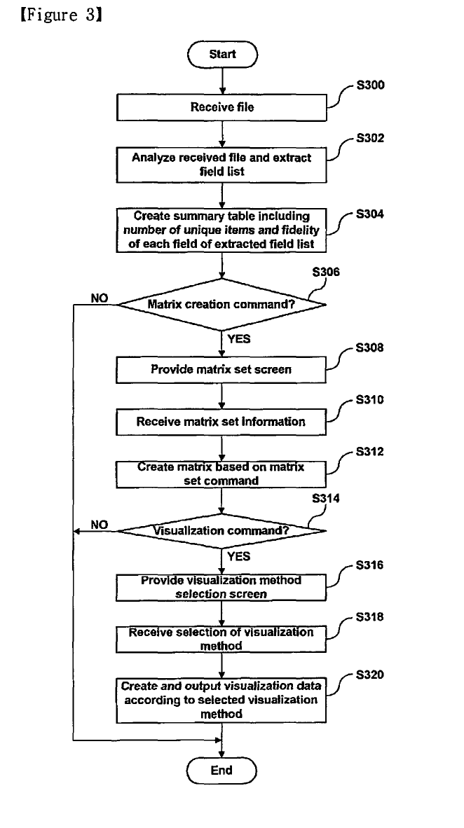

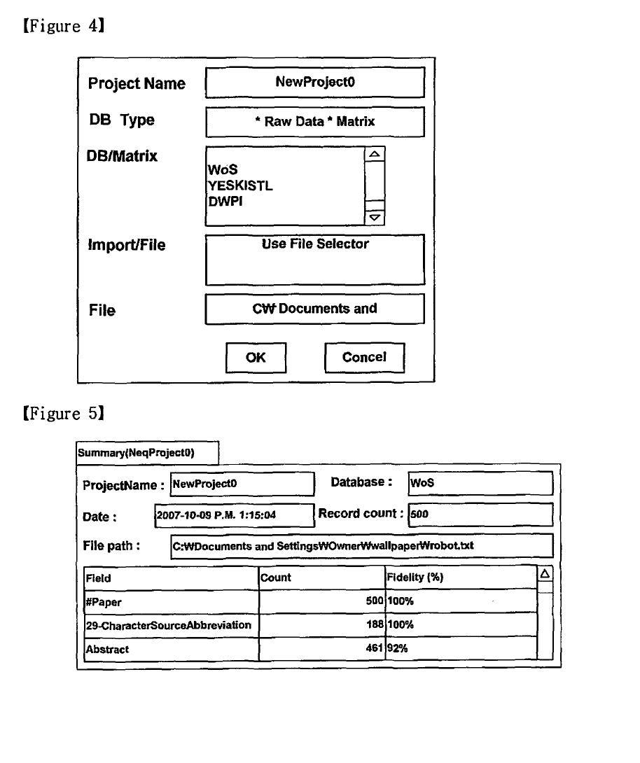

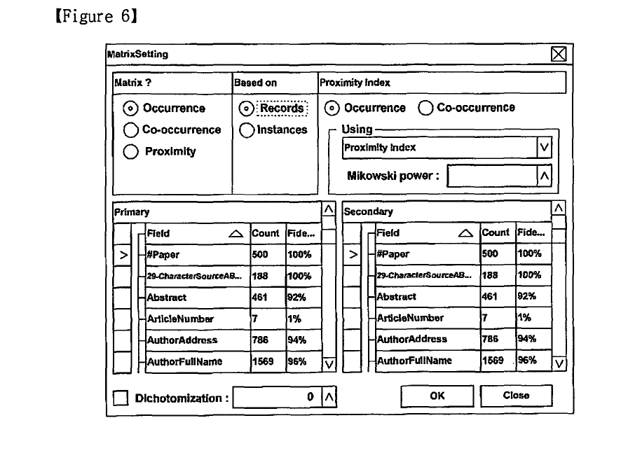

FIG. 3 is a flowchart illustrating a method of analyzing an inputted file by the information analysis server according to the present invention, FIG. 4 is an exemplary view showing a screen for inputting a file according to the present invention, FIG. 5 is an exemplary view showing a summary table screen according to the present invention, and FIG. 6 is an exemplary view showing a matrix setting screen according to the present invention.

Referring to FIG. 3, if a file is inputted S300, the information analysis server analyzes the inputted file and extracts a field list S302.

That is, if a user selects an information analysis menu, a file input screen as shown in FIG. 4 is displayed.

Referring to FIG. 4 for the file input screen, the file input screen includes a project name input area, a DB type input area, a DB form selection area, and a file input area (Import/File).

A corresponding project name is inputted in the project name input area, and a desired data type of either text data input or matrix input is selected from the DB type input area. If text data input is selected in the DB type input area, a DB form of the text data is selected from the DB form selection area, and the DB form may include WoS, YESKISTI, DWPI, and the like.

The file input area (Import/File) is configured with a use field selection area and a file search area. The use field selection area is used when fields other than basically set fields or only some of basic fields are selected.

The file search area is an area where an input file is searched for and the searched file is inputted.

If a file is inputted through the file input screen as described above, the information analysis server analyzes the inputted file and extracts a field list corresponding to the fields selected from the use field selection area.

Next, the information analysis server creates a summary table including the number of unique items and data fidelity of each field of the extracted field list S304.

The created summary table is meta information on an input data set to be analyzed as shown in FIG. 5.

Referring to FIG. 5 for the summary table, the summary table includes a project name, a database showing a DB form of input data, a date and time performing analysis, the number of input records, an input file path, a field list, the number of unique items of each field, and fidelity. The fidelity is a ratio of records where corresponding fields are filled.

If creation of a matrix is desired for each field of the summary table created in step

S304 and a matrix creation command is inputted S306, the information analysis server creates and provides a matrix setting screen to the client S308.

Referring to FIG. 6, the matrix setting screen is configured with a matrix type selection area, a matrix creation type selection area, and a proximity calculation type selection area.

Matrix types such as an occurrence matrix, co-occurrence matrix, proximity matrix, and the like are displayed in the matrix type selection area. The occurrence matrix is an occurrence matrix between two different fields, and the co-occurrence matrix is an occurrence matrix between same fields, which is calculated by applying an overlap function of the occurrence matrix. The proximity matrix is calculating the number of records created between two fields by applying a proximity algorithm.

There are Records and Instances in the matrix creation type selection area. The

Records is creating a matrix based on records, which obtains a matrix by calculating appearance of field data in the records, and the Instances is obtaining a matrix by calculating the number of field data appearing in a record.

The proximity calculation type selection area is for selecting whether to use either an occurrence matrix or a co-occurrence matrix when proximity is calculated, and Parson's r, Cosine, Jaccard, Dice, Equivalence, Euclid, Squared Euclid, Minkowski p-Metric, and the like are provided as proximity coefficients.

If matrix setting information is inputted S310 through the matrix setting screen displayed in step S308, the information analysis server creates a matrix from the contents of the summary table based on the matrix setting information S312. Values of the created matrix are displayed together with a field list.

If the client desires visualization of the created matrix and selects a visualization command S314, the information analysis server displays a visualization method selection screen S316. The visualization method selection screen includes a chart, clustering, FDP, strategic map, and the like. The user selects a desired visualization method through a visualization method providing screen.

In addition, the client may input a visualization command using a predetermined visualization method selection button.

If a visualization method is selected through the visualization method selection screen S318, the information analysis server creates visualization data for the created matrix according to the selected method and outputs the visualization data S320. A chart, FDP, strategic map, and the like are displayed on the visualization method providing screen.

For example, if the user selects the strategic map as a visualization method, the information analysis server outputs the created matrix as a strategic map.

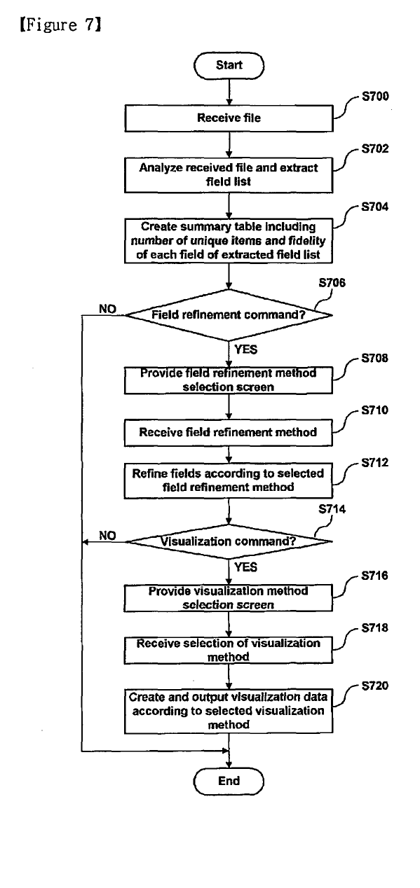

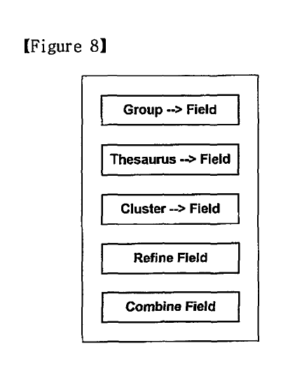

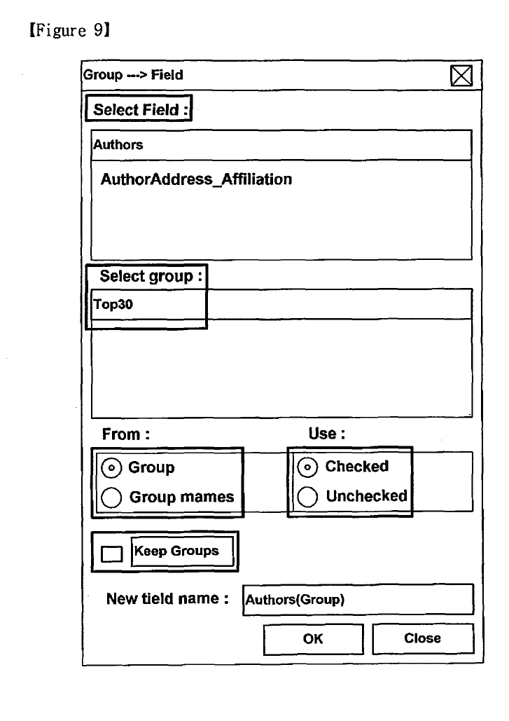

FIG. 7 is a flowchart illustrating a method of refining field information by the information analysis server according to the present invention, FIG. 8 is an exemplary view showing a screen for selecting a method of refining a field according to the present invention, and FIGS. 9a and 9b are exemplary views showing a screen for creating a field according to the present invention.

Referring to FIG. 7, if a file is inputted S700, the information analysis server analyzes the inputted file and extracts a field list S702.

Next, the information analysis server creates a summary table including the number of unique items data fidelity of each field of the extracted field list S704.

If refinement of the fields of the created summary table is desired and a field refinement command is inputted S706, the information analysis server creates and provides a field refinement method selection screen to the client S708.

Referring to FIG. 8, the field refinement method selection screen includes field creation methods such as creation of a field using a group (Group-Field), creation of a field using a thesaurus (Thesaurus-Field), creation of a field using a cluster (Cluster-Field), Refine Field, Combine Field, and the like.

If a field creation command is selected using the group, a field creation screen as shown in FIG. 9a is displayed.

Referring to FIG. 9a, ‘Select field’, ‘Select group’, ‘From’, ‘Use’, ‘Keep Groups’, and ‘New field name’ are displayed on the field creation screen.

The ‘Select field’ displays a field where a group is created, and the ‘Select group’ displays a group created in a field selected from the ‘Select field’. ‘Group’ displayed in the ‘From’ means creation of a new field using the name of field data contained in a selected group, and ‘Group Names’ means creation of a new field using the name of a selected group. ‘Checked’ in the ‘Use’ means creation of a new field using field data contained in a group, and ‘Unchecked’ means creation of a new field using field data not contained in a group. If ‘Keep Groups’ is checked, a group created in an existing field is maintained in a newly created field, and ‘New field name’ is an area for setting a newly created field name.

A field creation command using a thesaurus (Thesaurus-Field) is selected, a field creation screen as shown in FIG. 9b is displayed.

A field to which a thesaurus is applied is selected from ‘Fields’ of the field creation screen, and a thesaurus to be applied is selected from ‘Thesaurus’. If ‘Contain unmatched field data’ is checked, even field data not contained in an applied thesaurus are included in a newly created field.

That is, creating a field using the thesaurus is selecting a field to which a thesaurus is applied and creating a new field by selecting a thesaurus to be applied.

‘Refine Field’ is refining fields by removing duplicated items using a string matching algorithm.

‘Combine Field’ is creating a new field by selecting fields different from each other.

The user selects a desired field creation method from the field refinement method selection screen.

If a field creation method is selected S710 through the field refinement method selection screen displayed in step S708, the information analysis server refines the fields according to the selected field creation method S712.

Next, if visualization of the refined fields is desired and a visualization command is selected S714, the information analysis server displays a visualization method providing screen S716.

If a visualization method is selected through the visualization method providing screen S718, the information analysis server outputs information on the refined fields according to the selected visualization method S720.

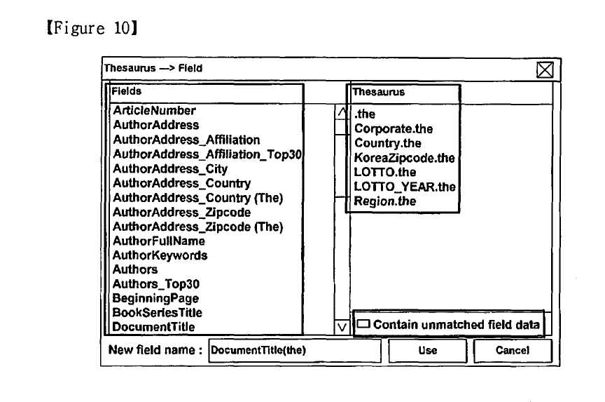

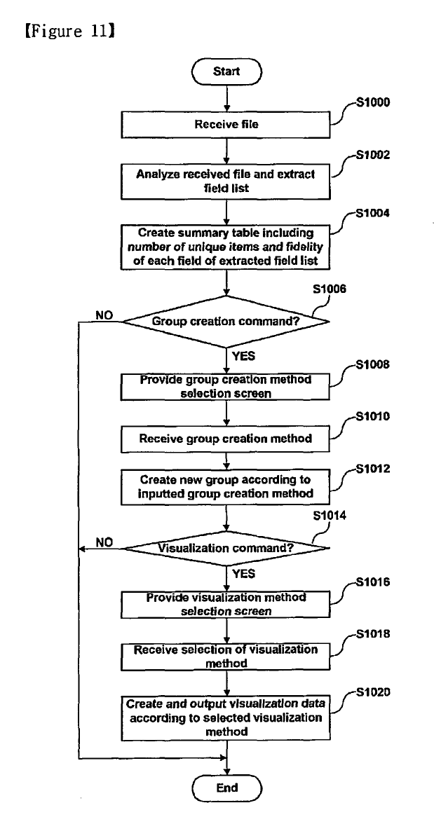

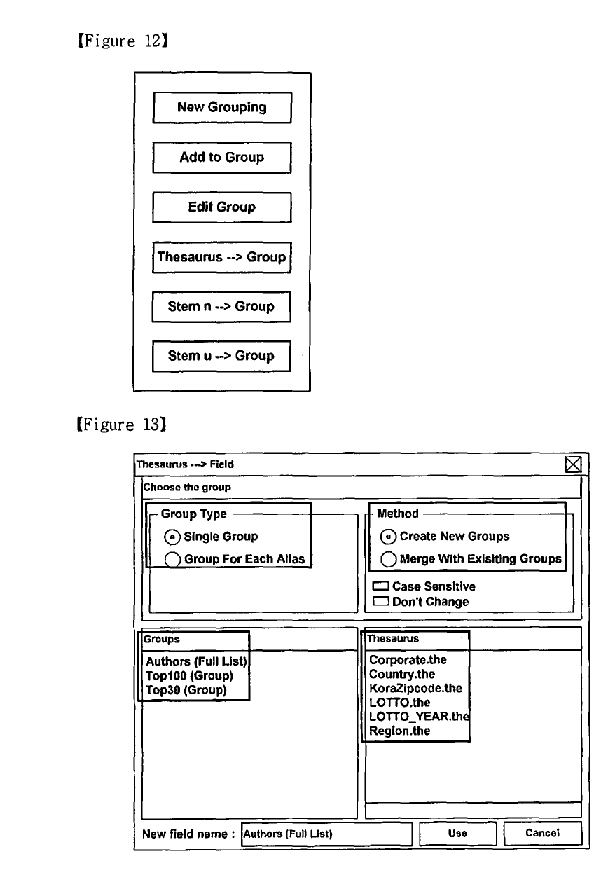

FIG. 10 is a flowchart illustrating a method of creating a group by the information analysis server according to the present invention, FIG. 11 is an exemplary view showing a screen for selecting a method of creating a group according to the present invention, and FIG. 12 is an exemplary view illustrating a method of creating a group using a thesaurus according to the present invention.

Referring to FIG. 10, if a file is inputted S1000, the information analysis server analyzes the inputted file and extracts a field list S1002.

Next, the information analysis server creates a summary table including the number of unique items and data fidelity of each field of the extracted field list S1004.

If creation of a new group using the fields of the created summary table is desired and a group creation command is inputted S1006, the information analysis server creates and provides a group creation method selection screen to the client S1008.

Referring to FIG. 11, the group creation method selection screen displays group creation methods such as ‘New Grouping’, ‘Add to Group’, ‘Edit Group’, ‘Thesaurus->Group’, ‘Stem n->Group’, ‘Stem U->Group’, and the like.

‘New Grouping’ is adding a new group, and ‘Add to Group’ is displaying a created group in a currently activated field. ‘Edit Group’ is managing a group, such as creating a group, deleting a created group, changing a name of a group, and the like.

‘Thesaurus->Group’ is creating a group using a thesaurus, and if ‘Thesaurus->Group’ is selected, a group creation screen as shown in FIG. 12 is provided. Referring to FIG. 12, the group creation screen includes a group selection area, a method selection area, a group name input area, and a thesaurus area.

‘Single Group’ and ‘Group For Each Alias’ are displayed in the group selection area. ‘Single Group’ is creating a group using all field data contained in ‘Thesaurus’, and ‘Group For Each Alias’ is creating a group using each of Thesaurus items where field data is contained.

‘Create New Groups’ and ‘Merge With Existing Groups’ are displayed in the method selection area. ‘Create New Groups’ is creating a new group if a group having the same name exists, and ‘Merge With Existing Groups’ is recognizing a group as the same group if the group has the same name.

A file name and a group name to which a thesaurus file is applied are selected from the group name input area, and a thesaurus file to be applied is selected from the Thesaurus area.

‘Stem n->Group’ is applying stemming to all field data of an activated list window and creating a group using field data corresponding to selected field data through the ‘And’ condition.

‘Stem U->Group’ is applying stemming to all field data of an activated list window and creating a group using field data corresponding to selected field data through the ‘Or’ condition.

The user selects a desired group creation method from the group creation selection screen.

If a group creation method is selected S1010 through the group creation method selection screen displayed in step S1008, the information analysis server creates a new group according to the selected group creation method S1012.

Next, if visualization of the fields displayed in the newly created group is desired and a visualization command is selected S1014, the information analysis server displays a visualization method providing screen S1016.

If a visualization method is selected through the visualization method providing screen S1018, the information analysis server outputs information on the fields contained in the created group according to the selected visualization method S1020.

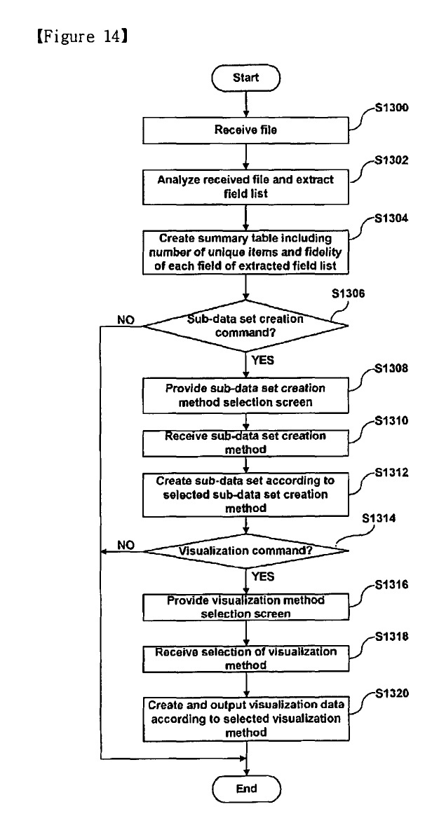

FIG. 13 is a flowchart illustrating a method of creating a sub-data set according to the present invention, and FIG. 14 is an exemplary view showing a screen for selecting a method of creating a sub-data set according to the present invention.

Referring to FIG. 13, if a file is inputted S1300, the information analysis server analyzes the inputted file and extracts a field list S1302.

Next, the information analysis server creates a summary table including the number of unique items and data fidelity of each field of the extracted field list S1304.

If creation of a new sub-data set for each field of the created summary table is desired and a sub-data set creation command is inputted S1306, the information analysis server displays a sub-data set creation method selection screen S1308.

Referring to FIG. 14, the sub-data set creation method selection screen displays ‘Select->Database’ and ‘Group->Database’. ‘Select->Database’ is creating a sub-data set using a group, in which the sub-data set is created using field data contained in a selected group or field data not contained in the selected group.

‘Group->Database’ is creating a sub-data set using field data selected or not selected from an activated list window.

If a sub-data set creation method is selected S1310 through the sub-data set creation method selection screen displayed in step S1308, the information analysis server creates a new sub-data set according to the selected sub-data set creation method S1312.

Next, if visualization of the fields display in the newly created sub-data set is desired and a visualization command is selected S1314, the information analysis server displays a visualization method providing screen S1316.

If a visualization method is selected through the visualization method providing screen S1318, the information analysis server outputs the created sub-data set according to the selected visualization method S1020.

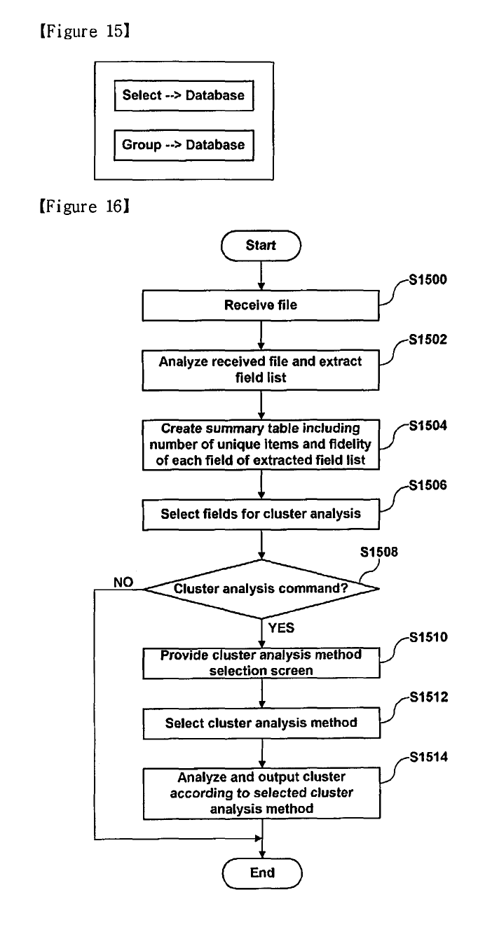

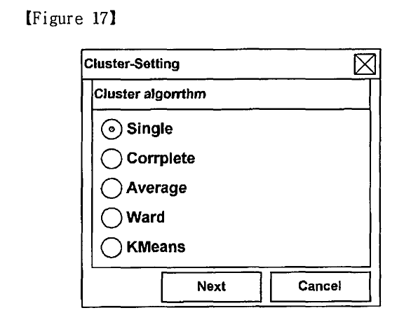

FIG. 15 is a flowchart illustrating a method of analyzing a cluster according to the present invention, and FIG. 16 is an exemplary view showing a screen for selecting a method of analyzing a cluster according to the present invention.

Referring to FIG. 15, if a file is inputted S1500, the information analysis server analyzes the inputted file and extracts a field list S1502.

Next, the information analysis server creates a summary table including the number of unique items and data fidelity of each field of the extracted field list S1504.

If cluster analysis for a specific field of the created summary table is desired and a cluster analysis command is inputted S1508 after a field is selected S1506, the information analysis server displays a cluster analysis method selection screen S1510.

Since the cluster analysis method selection screen is the same as shown in FIG. 16, referring to FIG. 16, the cluster analysis method selection screen displays analysis methods such as Single, Complete, Average, Ward, K-Means, and the like.

The user selects a desired cluster analysis method from the displayed cluster analysis method selection screen.

Then, the information analysis server analyzes a cluster for the selected field item according to the selected cluster analysis method S1512.

Next, if visualization of a result of the cluster analysis and a visualization method is selected S1514, the information analysis server outputs a result of the cluster analysis using the selected visualization method S1516.

### INDUSTRIAL APPLICABILITY

Although the present invention has been described with reference to several preferred embodiments, the description is illustrative of the invention and is not to be construed as limiting the invention. Various modifications and variations may occur to those skilled in the art, without departing from the scope of the invention as defined by the appended claims.

1. An information analysis system comprising:
a database for storing field list information and file information;
a summary table creation unit for analyzing an input file if the file is inputted, extracting a field list corresponding to the field list information stored in the database, and creating a summary table including the extracted field list;
a preprocessing module for performing a preprocess including at least one of field refinement, group creation, and sub-data set creation, for fields of the summary table created by the summary table creation unit;
a matrix creation unit for creating a matrix based on matrix setting information inputted by a user, for the fields created by the summary table creation unit or the preprocessing module;
a cluster analysis unit for analyzing a cluster of corresponding fields according to a cluster analysis method inputted by the user, for fields selected by the user among the fields created by the summary table creation unit or the preprocessing module; and
a visualization data creation unit for creating visualization data according to a visualization method selected by the user, for data created by at least one of the matrix creation unit, the preprocessing module, and the cluster analysis unit.

2. The system according to claim 1, wherein the visualization method includes at least one of a chart, a FDP, and a strategic map.

3. The system according to claim 1, wherein the file is inputted in a form of at least one of a web document, text, a word processing file, and a matrix.

4. The system according to claim 1, wherein the summary table created by the summary table creation unit includes the number of contents and fidelity of each field of the field list.

5. The system according to claim 1, wherein the preprocessing module comprises:
a field refinement unit for refining fields selected according to a field refinement method inputted by the user;
a group setting unit for setting a group according to a group setting method inputted by the user; and
a sub-data set creation unit for creating a sub-data set according to a sub-data set creation method inputted by the user.

6. The system according to claim 5, wherein the field refinement method is at least one of creation of a field using a group (Group-Field), creation of a field using a thesaurus (Thesaurus-Field), creation of a field using a cluster (Cluster-Field), Refine Field, and Combine Field.

7. The system according to claim 5, wherein the group setting method is at least one of New Grouping, Add to Group, Edit Group, creation of a group using thesaurus, and creation of a group using stemming.

8. The system according to claim 5, wherein the sub-data set creation method is one of a method of creating a sub-data set using a group and a method creating a sub-data set using field data.

9. The system according to claim 1, wherein the matrix setting information includes a matrix type, a matrix creation type, and a proximity calculation type.

10. The system according to claim 9, wherein the matrix type includes an occurrence matrix type, a co-occurrence matrix type, and a proximity matrix type.

11. The system according to claim 9, wherein the matrix creation type includes a matrix creation type based on a record and a matrix creation type using calculation of the number of field data appearing in a record.

12. The system according to claim 1, wherein the cluster analysis unit analyzes a cluster by extracting entities corresponding to the fields selected by the user from the database and calculating proximity among the entities.

13. The system according to claim 1, wherein the cluster analysis method includes at least one of Single, Complete, Average, Ward, and K-Means.

14. An information analysis method comprising the steps of:
(a) extracting a field list by analyzing an input file if the file is inputted, and creating a summary table including the number of unique items and data fidelity of each field of the extracted field list;
(b) providing a setting screen for an input command if at least one of a matrix creation command, a preprocessing command, and a cluster analysis command is inputted for the fields of the created summary table, and processing corresponding fields based on corresponding setting information if the setting information is inputted through the provided setting screen; and
(c) creating and outputting visualization data for a result of the processing according to a selected visualization method if a visualization command is inputted for the result of the performed processing.

15. The method according to claim 14, wherein step (a) comprises the steps of:
providing a file input screen if an information analysis menu is selected;
analyzing an input file and extracting a field list corresponding to fields selected through the file input screen, if the file is inputted through the file input screen; and
creating a summary table including the number of unique items and data fidelity of each field of the extracted field list.

16. The method according to claim 14, wherein step (b) comprises the steps of:
providing a matrix setting screen if a matrix setting command is inputted; and
creating a matrix based on matrix setting information for the fields of the created summary table if the matrix setting information is inputted through the matrix setting screen.

17. The method according to claim 16, wherein the matrix setting screen is configured with a matrix type selection area, a matrix creation type selection area, and a proximity calculation type selection area, wherein the matrix type selection area displays an occurrence matrix type, a co-occurrence matrix type, a proximity matrix type, and the matrix creation type selection area displays a record-based matrix creation type and a matrix creation type of calculating appearance of field data in a record.

18. The method according to claim 14, wherein step (b) comprises the steps of:
providing a corresponding preprocess setting screen if a preprocessing command including at least one of a field refinement, a group creation, and a sub-data set creation is inputted; and
performing a preprocess on corresponding fields based on preprocess setting information if the preprocess setting information is inputted through the preprocess setting screen.

19. The method according to claim 14, wherein step (b) comprises the steps of:
providing a cluster analysis method selection screen if a cluster analysis command is inputted for a specific field of the created summary table; and
analyzing a cluster for field items according to a cluster analysis method selected through the cluster analysis method selection screen.
